(19) United States
(12) Patent Application Publication
(10) Pub. No.: US 2010/0264388 A1
(43) Pub. Date: Oct. 21, 2010

(54) METAL FENCE ASSEMBLY AND METHOD

(76) Inventors: Gordon DUFFY, Fair Play, SC (US); Jason DUFFY, Jefferson, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/425,581

(22) Filed: Apr. 17, 2009

(51) Int. Cl. E04H 17/16; B23P 11/00

(52) U.S. Cl. 256/22; 29/505

(57) ABSTRACT

A fencing assembly is adapted to be positioned between a pair of posts and mounted to the posts. The fencing assembly includes a plurality of pickets and a plurality of rails extending transverse to the pickets. Optionally, sliding covers are provided for concealing the connection between the pickets and the rails.

### TECHNICAL FIELD

The present invention relates to fencing and method of producing fencing.

### BACKGROUND OF THE INVENTION

Fencing has existed for hundreds of years. Typical fencing comprises a series of vertical pickets that are attached to horizontal rails. In some types of fencing, the rails have holes through which the pickets extend therethrough, which are then connected using fasteners such as screws or by a welding. As these fasteners tend to wear over time, the durability of the fence can be dependant on the fastener.

Accordingly, there is always a need for improved fence systems or assemblies. This invention is directed to this need, among others.

### SUMMARY

Briefly, one specific embodiment of this invention includes a fencing assembly adapted to be positioned between a pair of posts and mounted to the posts. The fencing assembly includes a plurality of pickets and a plurality of rails extending transverse to the pickets. The rails have a plurality of openings for receiving the pickets therethrough. The rails can be coupled or pivotally connected to the pickets by a protuberance in the rail and a recess in the picket so as to form a connection between the picket and the rail; the interconnection between the protuberance and the recess result is a connection between the rail and the picket. Sliding covers can be provided over the protuberances to conceal the connection between the pickets and the rails. For example, a sliding strip can be slidably mounted onto the rails and are captured therein. In some examples, the fence may be constructed without the use of screws or bolts.

In some embodiments, the recesses may be a dimples (or apertures) formed in the pickets and the protuberances may be formed in the rails. Optionally, the recesses comprise dimples or may include apertures. Alternatively, the dimples could be formed in the rails and the protuberances formed in the pickets. Instead of or in addition to the dimples and protuberances, other connections can be employed between the pickets and the rails. For example, a series of holes could be drilled in the pickets for receiving nubs or the like formed on the rails.

In one embodiment, the connection between a rail and the pickets is not readily visible, after the fencing assembly has been assembled.

In one specific embodiment, the recesses or dimples may be formed in the pickets and the protuberance may be formed in the rails using a press tool. For example, a tool may be appropriately positioned over a rail then pressed forcibly against the rail to deform both the rail and the pickets. Also, optionally, a series or cluster of tools can be pressed against the rail to deform both the rail and a plurality of pickets all at the same time. Alternatively, the recesses and the protuberance may be formed independently. The recesses may also be formed in the pickets and the protruberabances may be formed in the rail simultaneously by first positioning a rail over the pickets and then pressing a gang of tools against the rail to deform both the rail and the plurality of pickets all at the same time.

One specific manufacturing method for a fencing assembly includes the steps of providing a series of pickets in a spaced-apart relationship, providing a generally U-shaped rail with picket recesses formed an upper portion thereof, the rail including a profile for receiving and retaining a sliding cover; slipping the U-shaped rail over the pickets, with a portion of the pickets extending through the picket recesses formed in the rail, forcing a tool against the rail to deform both the rail and the pickets to create a fastener-less connection between the pickets and the rail, providing a sliding cover; and sliding the sliding cover into engagement with the rail to conceal the fastener-less connection between the pickets and the rail. The step of forcing a tool against the rail is effective to form recesses in the pickets and form protuberance in the rail.

### BRIEF DESCRIPTION OF THE DRAWINGS

FIG. 1 is a front elevation view of a metal fence assembly according to preferred form of the present invention.

FIG. 2 is a detailed, sectional view of a portion of the metal fence assembly of FIG. 1.

FIG. 3 is a detailed, sectional view of a portion of the metal fence assembly of FIG. 1.

FIG. 4 is a detailed, sectional view of a portion of the metal fence assembly of FIG. 1 depicting a manufacturing operation thereof.

FIG. 5 is a detailed, sectional view of a portion of the metal fence assembly of FIG. 1 in an alternate form and depicting a manufacturing operation thereof.

FIG. 6 is a detailed, sectional view of a portion of the metal fence assembly of FIG. 1 depicting a manufacturing operation thereof in an alternate form.

FIG. 7 is a detailed, sectional view of a portion of a metal fence assembly in an alternate form of the invention.

### DETAILED DESCRIPTION

The fence assembly 10 according specific embodiments of this invention a fencing assembly that can reduce both manufacturing and installation costs be reducing the need for fasteners. More specifically, the fence assembly 10 provides a system of pickets 20 and support rails 30 (collectively) that can be held in place by appropriately positioned dimples 40.

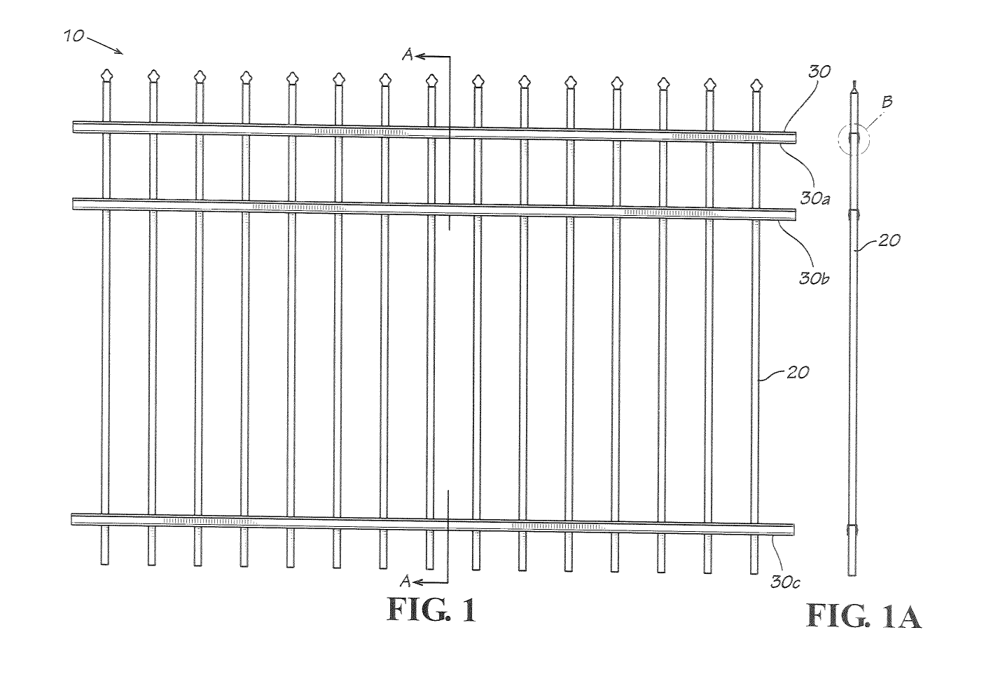

Referring now to FIG. 1, the fencing assembly 10, when mounted, can be used to enclose yard spaces, decks, porches and the like. The fence assembly 10 includes a plurality of horizontally spaced pickets 20 and at least one support rail 30. In the exemplary embodiments, the railing assembly 10 comprises three individual support rails 30a, 30b, 30c (as seen in FIG. 1) to space, align, and secure the pickets 20 and to provide for structural rigidity. Each picket 20 can also include an endcap coupled to the top of the same (or formed in the top portion itself) to close off the top of the picket and/or to provide a decorative element to the railing assembly 10. In exemplary embodiments, the pickets 20 and rails 30 can be formed from extruded metal. In exemplary embodiments, the pickets 20 are square aluminum extrusions and the rails 30 are roughly rectangular aluminum extrusions (but U-shaped). While specific shapes of fence components such as the rails and pickets are shown in the figures, it is contemplated that the style and particular applications for picket and rail fences can shape the size and design of fence assembly.

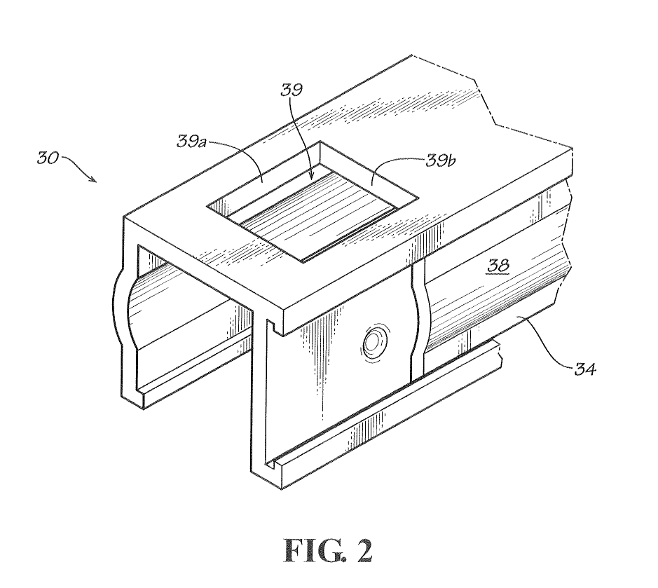

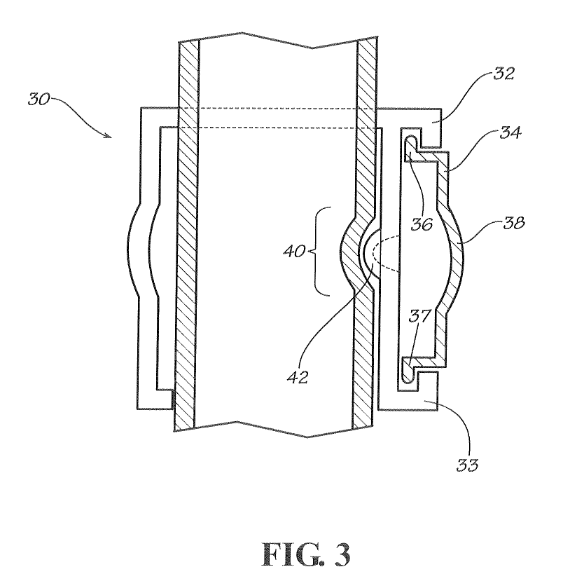

As shown in FIGS. 2 and 3, the rails 30 can have a substantially “U” shaped cross-section and generally in use, are oriented open-side-down such that the “bottom” of the “U” forms the top of the rail 30. In alternative embodiments, the rails 30 can have a substantially “J” shaped cross-section or rectangular shaped cross-section. In still other embodiments, the rails 30 can include other cross-sections as desired.

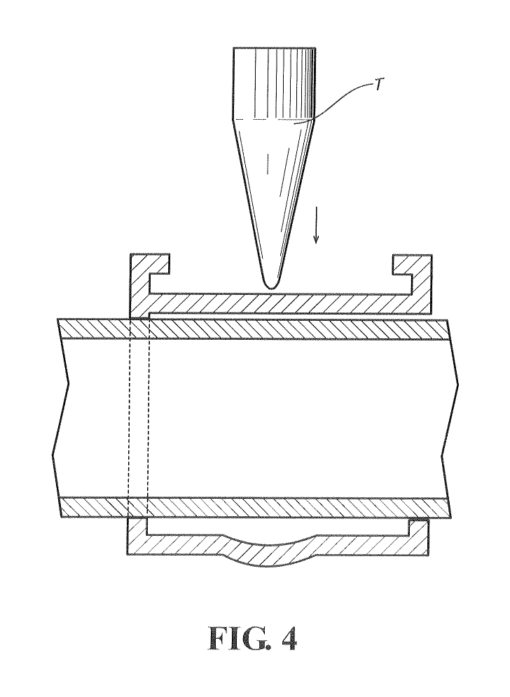

As shown in FIGS. 3 and 4, the rails 30 include a pair of L-shaped guides 32, 33 for guiding, securing and supporting a cover strip 34 (or alternatively referred to as a concealment strip) thereon. Once in place, the cover strip 34 may be securely held there by the guides 32, 33. The cover strip 34 includes a pair of feet or nubs 36, 37 for being slidably captured by the guides 32, 33 of the cover strip 34. In exemplary embodiments, the cover strip 34 is captured by the rail body and is permitted to slide horizontally along the rail 30 (at least until the fencing assembly is assembled).

In one embodiment, each of the rails 30 may include a plurality of dimples 40 for receiving a picket at a bulge 42. The dimple 40 can be shaped to accept at least a portion of the bulge 42, so to help secure the picket within the rail 30. As shown, the cross-sectional shape dimple 40 providing some clearance between the extension and the side surfaces of the pickets. In one example, the clearance front-to-back is smaller than the clearance side-to-side. Providing greater clearance side-to-side allows for greater range of “racking”—a greater range of angles between the pickets and the rails to better follow rising or falling terrain. However, it is contemplated that greater clearance may require a deeper protuberance.

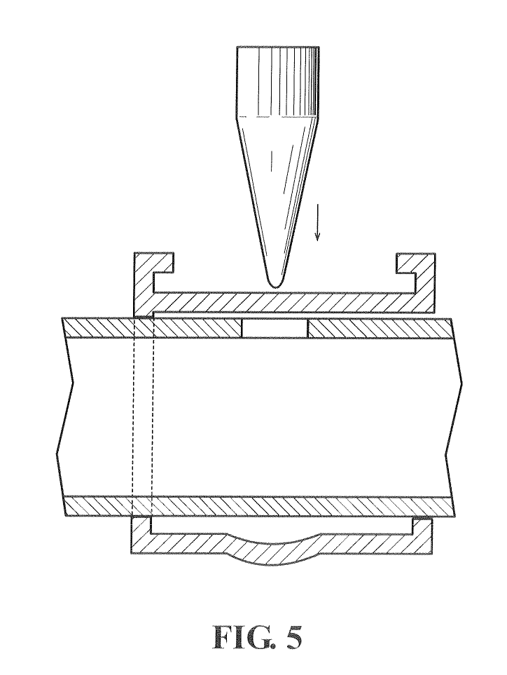

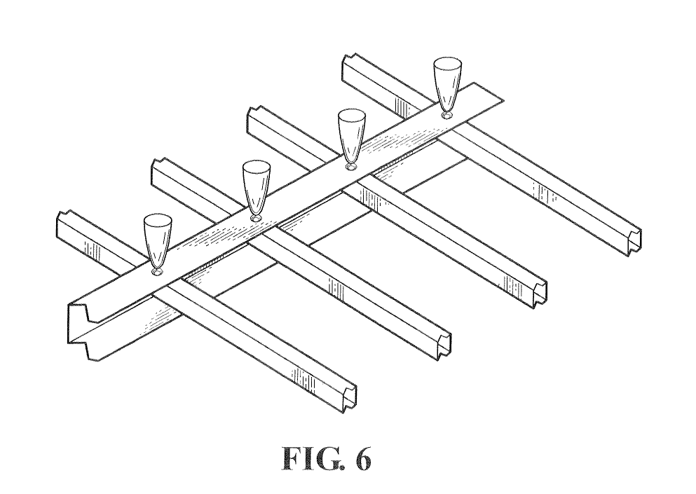

As shown in FIGS. 4, 5 and 6, the fence assembly can be manufactured using a manufacturing operation incorporating one or more pressing tools T. For example, FIG. 4 shows that the dimples can be formed independently using a single pressing tool T by selecting the appropriate position of the dimple along the appropriate face of the rail 30 and pressing the pressing tool T therein. Alternatively, FIG. 5 shows that multiple dimples may be simultaneous formed using a series or cluster of tools T by pressing the series of tools T into the appropriate places along the rail 30. One ordinary skill in the art may create the dimples 40 in the rail 30 using methods known in the art.

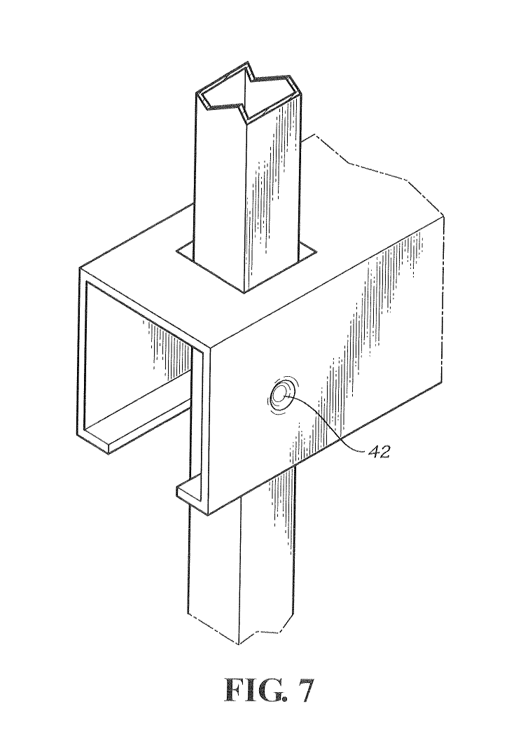

As shown in FIG. 7, a sectional view of a portion of a metal fence assembly in an alternate form of the invention. In this embodiment, the faces of rails are squared off so to avoid the need for the cover strips 34 shown in FIG. 1. As shown, the dimples can be placed in the back face of the rail 30, so that the dimples are not seen from the front of the fence, which improves the overall appearance of the fencing assembly.

In exemplary embodiments, the protuberance is shown as a bulge 40 on the exterior surface of the rail. It is contemplated, that in alternative example embodiments other exterior shapes, can be utilized as desired. For example, a star shape or diamond type of shape may be pressed into the rail 30. One of ordinary skill in the art may select an appropriate shape without undue experimentation.

In use and application, fence assembly 10 can be used to prepare a fence between along using a series of pickets 20 and rails 30. More particularly, a method for preparing such a fence can have the steps of:

(a) providing a series of pickets in a spaced-apart relationship;

(b) providing a generally U-shaped rail with picket recesses formed an upper portion thereof, the rail including a profile for receiving and retaining a sliding cover;

(c) slipping the U-shaped rail over the pickets, with a portion of the pickets extending through the picket recesses formed in the rail;

(d) forcing a tool against the rail to deform both the rail and the pickets to create a fastener-less connection between the pickets and the rail;

(e) providing a sliding cover; and

(f) sliding the sliding cover into engagement with the rail to conceal the connection between the pickets and the rail.

While the fence assembly 10 is disclosed as manufactured of aluminum, the picket and rail assembly can be easily and readily manufactured other materials. For example, the pickets and rails can be formed from other materials such metals and/or metal alloys, wood, rubber, plastic, and/or other materials available in the art.

While the invention has been described with reference to preferred and example embodiments, it will be understood by those skilled in the art that a variety of modifications, additions and deletions are within the scope of the invention, as defined by the following claims.

What is claimed is:

1. A fencing assembly adapted to be positioned between a pair of posts and mounted thereto, the assembly comprising:
a plurality of pickets;
a plurality of rails extending transverse to the pickets and having a plurality of openings formed along an upper portion thereof for receiving the pickets therethrough, the rails by a protuberance formed in one of the rail and the picket engaging a recess formed in the other of the rail and the picket so as to form a connection therebetween; and
a plurality of sliding covers for concealing the pivotal connection between the pickets and the rails, the sliding covers being slidably mounted to the rail and being captured therein.

2. A fencing assembly as claimed in claim 1, wherein the recesses are formed in the pickets and the protuberances are formed in the rails.

3. A fencing assembly as claimed in claim 1, wherein the connection is pivotal.

4. A fencing assembly as claimed in claim 1, wherein the recesses comprise dimples formed in the pickets.

5. A fencing assembly as claimed in claim 1, wherein the recesses comprise apertures formed in the pickets.

6. A fencing assembly as claimed in claim 3, wherein the dimples formed in the pickets and the protuberances formed in the rails are formed at the same time by first positioning a rail over the pickets and then pressing a tool against the rail to deform both the rail and the pickets.

7. A fencing assembly as claimed in claim 5,
wherein the dimples formed in the pickets and the protuberances formed in a rail are formed at the same time by first positioning a rail over the pickets and then pressing a gang of tools against the rail to deform both the rail and the pickets all at the same time.

8. A fencing assembly as claimed in claim 7,
wherein the pickets have a rectangular cross section.

9. A fencing assembly as claimed in claim 7,
wherein the rails are generally U-shaped.

10. A fencing assembly as claimed in claim 1,
wherein, when assembled, the fastener-less connection between a rail and the pickets is not readily visible from the exterior of the assembly.

11. A method of manufacturing a fencing assembly to be positioned between a pair of posts and mounted thereto, the method comprising the steps of:
providing a series of pickets in a spaced-apart relationship;
providing a rail with picket recesses formed an upper portion thereof, the rail including a profile for receiving and retaining a sliding cover;
slipping the rail over the pickets, with a portion of the pickets extending through the picket recesses formed in the rail;
forcing a tool against the rail to deform one or both the rail and the pickets to create a connection between the pickets and the rail;
providing a sliding cover; and
sliding the sliding cover into engagement with the rail to conceal the fastener-less connection between the pickets and the rail.

12. A method as claimed in claim 11,
wherein the rail has generally U-shaped cross section.

13. A method as claimed in claim 11,
wherein the step of forcing a tool against the rail creates dimples in the pickets and forms protuberances in the rail.

14. A method as claimed in claim 12,
wherein the dimples formed in the pickets and the protuberances formed in the rail are formed at the same time by first positioning a rail over the pickets and then pressing a gang of tools against the rail to deform both the rail and the plurality of pickets all at the same time.

15. A method as claimed in claim 11,
wherein the pickets, the rails, and the sliding cover all comprise aluminum extrusions.

16. A method as claimed in claim 11,
wherein further comprising the step of forming apertures in the pickets, and the step of deforming one or both the pickets and the rails comprises deforming the rails to form a protuberance that extends into the corresponding recess in the picket.

17. A method as claimed in claim 11,
wherein the rail and the picket have cross sections that are substantially square.
